(19) United States
(12) Patent Application Publication
(10) Pub. No.: US 2010/0227231 A1
(43) Pub. Date: Sep. 9, 2010

(54) FUEL CELL APPARATUS

(76) Inventor: Timo Kivisaari, Helsinki (FI)

Correspondence Address: Muncy, Geissler, Olds & Lowe, PLLC, 4000 Legato Road, Suite 310, FAIRFAX, VA, 22033, US

(21) Appl. No.: 12/678,033

(22) PCT Filed: Sep. 30, 2008
(86) PCT No.: PCT/FI2008/050545

§ 371 Date: Mar. 12, 2010

(30) Foreign Application Priority Data
Oct. 3, 2007 (FI) 20075699

(51) Int. Cl. H01M 8/06

(52) U.S. Cl. 429/416

(57) ABSTRACT

A method of operating a fuel cell apparatus (1), which fuel cell apparatus comprises a fuel cell unit (2), the fuel cells of which enclose an anode (3) and a cathode (4) and an electrolyte (5) there between, a fuel channel (7) for conveying fuel to the anode (3), and a processing apparatus (10) arranged in conjunction with the fuel channel (7) for producing a hydrogenous fuel gas from an alcohol fuel. In the method alcohol fuel is led to the processing apparatus (10) along the fuel channel (7), hydrogenous fuel gas is produced from the alcohol fuel in the processing apparatus (10), fuel gas is discharged from the processing apparatus (10) to the anode (3), fuel gas is combusted on the anode (3), and exhaust gas generated during the combustion of the fuel gas is led from the anode (3) into the fuel channel (7). Water is mixed with the alcohol fuel in the fuel channel (7) before it is conveyed to the processing apparatus (10).

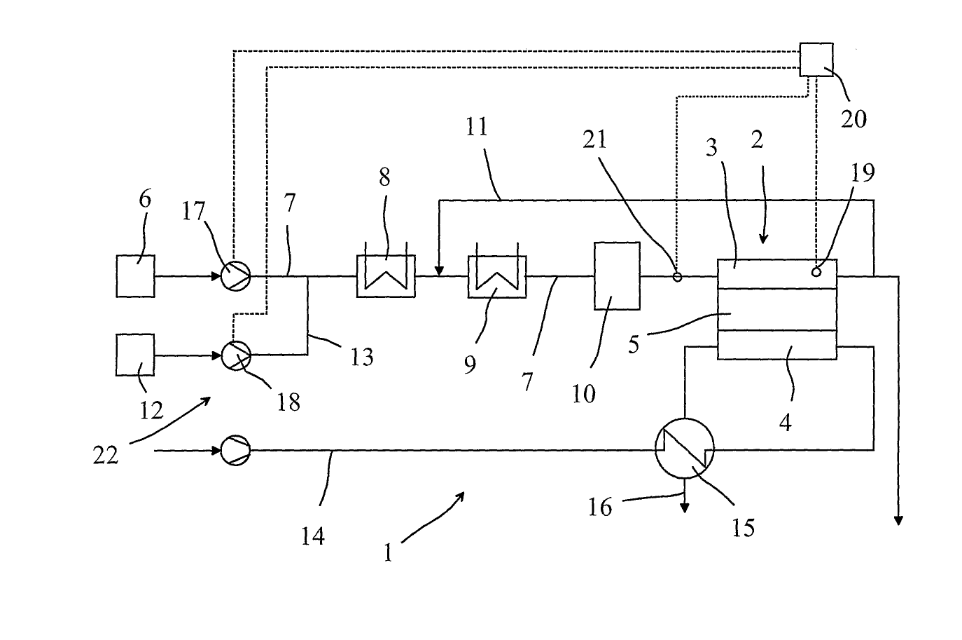

The present invention relates to a fuel cell apparatus. The invention also relates to a method of operating a fuel cell apparatus.

A fuel cell is an electrochemical device that produces electric current from the chemical energies of hydrogen and oxygen used as a fuel, without any conventional flame combustion. A fuel cell contains two electrodes, an anode and a cathode, between which there is a medium that conducts ions, i.e. an electrolyte. Usually, the fuel comprises natural gas or other hydrocarbon mixtures or alcohols, such as methanol or ethanol. This initial fuel is converted first to a fuel used by the fuel cell, for instance by reforming, or it is introduced directly to the fuel cell and transformed there to a fuel suitable for the fuel cell. The processed fuel is introduced to the anode of the fuel cell and correspondingly, the oxygen required in the reactions taking place in the fuel cell is introduced to the cathode of the fuel cell, e.g. in the form of air. In the reaction taking place in the fuel cell the electrons are released from the hydrogen of the fuel gas on the anode and travel to the cathode of the fuel cell via an external circuit, i.e. a load connected subsequent to the fuel cell. On the cathode, the electrons and oxygen react and form oxide ions, which are carried through the electrolyte to the anode thus closing the circuit. Next, on the anode of the fuel cell the hydrogen ions and oxide ions are united to form water. In this overall process, in addition to water, also heat and electricity are produced. The electricity is directly recovered as electric energy without any need to convert it first into mechanical form.

The anode of a solid oxide fuel cell (SOFC) comprises usually nickel in the form of small particles in a porous ceramic matrix. In conjunction with the start-up and shut-down of the fuel cell apparatus a reducing environment needs to be ensured for the anode side of the fuel cell, whereby it is secured that the nickel portion of the anode is not oxidised. If oxidised, nickel forms nickel oxide, which leads to cubic expansion, as a result of which the structure of the nickel ceramic matrix of the anode may break or the components of the fuel cell, the anode, cathode and electrolyte come off from each other. Even an oxide layer formed on the nickel portion of the anode surface as a result of partial oxidation also decreases the efficiency of the fuel cell, since only a clean nickel surface is catalytically active.

An object of the present invention is to provide a solution, by which oxidation of the anode of a fuel cell can be decreased.

The objects of the invention are achieved as disclosed in the appended claim 1. The fuel cell apparatus according to the invention comprises a fuel cell unit, the fuel cells of which contain an anode and a cathode and an electrolyte therebetween. In addition, the fuel cell apparatus comprises a fuel channel for conveying fuel to the anode, and a processing apparatus arranged in conjunction with the fuel channel for producing a hydrogenous fuel gas from an alcohol fuel. Alcohol fuel is led to the processing apparatus along the fuel channel and hydrogenous fuel gas is produced from the alcohol fuel in the processing apparatus. Subsequently, the hydrogenous fuel gas is conveyed from the processing apparatus to the anode. According to the invention, water is mixed with the alcohol fuel in the fuel channel before it is conveyed to the processing apparatus.

Considerable advantages are achieved by the present invention.

Water is mixed with the alcohol fuel of the fuel cell before it is conveyed to the processing apparatus, whereby the fuel gas produced in the processing apparatus possesses enough reducing power to prevent oxidation of the nickel material of the anode. Preferably, the fuel cell apparatus according to the invention uses alcohol fuel, such as methanol or ethanol, as its primary fuel, whereby reducing fuel gas can be easily produced by mixing a sufficient amount of water with the primary fuel flowing in the fuel channel. Thus, there is no need for separate feeds for reducing gas and fuel, respectively.

In one embodiment of the invention the amount of water to be mixed with the alcohol fuel is adjusted so that the hydrogen content of the fuel gas after the processing apparatus is less than the lower ignition limit of hydrogen, i.e. the hydrogen content is 5 volume percent at the most, preferably less than 4 volume percent. Thus, the generation of an explosive gas mixture in the vicinity of the anode is avoided. The mixing of water with the fuel may be reduced, when the fuel cell unit has reached the self-ignition temperature of hydrogen (about 585° C.). However, water needs to be introduced continuously to the fuel processing system to such an extent that the molar water/carbon ratio of the mixture is always at least 2. Thus, the formation of carbon in the fuel processing apparatus and in the subsequent heat exchanger is avoided. In practise, this may be provided by mixing water directly with the alcohol fuel and/or by recirculating some of the exhaust gases of the anode that contain water vapour.

In the following, the invention will be explained more in detail in an exemplary way with reference to the appended drawing. The drawing is a simplified schematic view of one fuel cell apparatus according to the invention.

The fuel cell apparatus 1 shown in the drawing comprises a fuel cell unit 2 with a plurality of fuel cells. In the drawing, the fuel cells of the fuel cell unit are shown schematically as one entity. The fuel cells are solid oxide fuel cells (SOFC) or molten carbonate fuel cells (MCFC). A fuel cell contains an anode 3 and a cathode 4 and an electrolyte 5 therebetween. The anode 3 contains readily oxidable metal, such as nickel, which is generally in the form of small particles in a porous ceramic matrix.

As a fuel in the fuel cell apparatus 1 an expedient alcohol, advantageously ethanol or methanol, is used. Alcohol is the primary fuel in the fuel cell apparatus 1. No other fuel is used in the fuel cell apparatus 1. Fuel is fed from a fuel tank 6 or another fuel source by a fuel pump 17 to a fuel channel 7 and along the channel to an evaporator 8, in which the fuel is evaporated. The fuel in the fuel tank 6 is undiluted. The volume flow rate of the fuel to be introduced into the fuel channel 7 is controlled by means of the fuel pump 17. The evaporated fuel is led from the evaporator 8 along the fuel channel 7 to a superheater 9, in which the fuel vapour is superheated. Water vapour produced from the exhaust gases of the anode 3 is mixed with the evaporated fuel between the evaporator 8 and the superheater 9. In this manner the water content of the fuel mixture is increased in order to prevent formation of carbon in the superheater 9.

After the superheater 9, the fuel vapour is led along the fuel channel 7 to a fuel processing apparatus, i.e. a combined steam reformer/methanator reactor 10, in which the fuel is first steam-reformed and then methanised. In the steam reformer section of the reactor the alcohol in the fuel is cracked by means of a catalyst and water vapour into hydrogen (H₂), carbon dioxide (CO₂), carbon monoxide (CO) and water vapour (H₂O). In the methanator section of the reactor the carbon dioxide and carbon monoxide react with hydrogen on the surface of the same catalyst and form methane and water vapour. After the reforming and methanising, the fuel gas in gaseous form is led along the fuel channel 7 to the anode side 3 of the fuel cell. Air or other oxygenous gas is led to the cathode side 4 of the fuel cell along an air duct 14. The fuel is “combusted” on the anode 3, whereby electricity and heat are produced in the fuel cell. While the fuel is combusted, exhaust gas is formed, some of which is recirculated along a return channel 11 back to the fuel channel 7 in the flow direction of the fuel to a location before the reformer/methanator 10 and mixed with the fuel. Exhaust gas is led into the fuel channel 7 to a location between the evaporator 8 and the superheater 9 or into the evaporator 8. The exhaust gas to be led into the fuel channel 7 consists mainly of water vapour. Some of the exhaust gas on the cathode side 4 is led along an exhaust duct 16 to a heat exchanger 15, in which the air to be led to the cathode 4 is heated by the exhaust gas.

In the normal operational mode of the fuel cell apparatus 1 the temperature in the fuel cell unit 2 rises typically up to about 800-1000° C. In the start-up and shut-down of the fuel cell apparatus 1 the temperature of the fuel cell unit 2 is lower than the normal operating temperature, whereby the recirculation of exhaust gas from the anode side 3 along the return channel 11 to the fuel channel 7 does not work yet or it works with reduced effect. Consequently, the reducing power of the fuel gas decreases and an oxidising atmosphere might be created on the anode 3, e.g. if oxygen escapes from the cathode side to the anode side or air enters the anode side for some other reason, e.g. during the shut-down of the system. Due to this oxygen, the nickel material of the anode may become oxidised into nickel oxide (NiO). An oxidised material expands, whereby either the structure of the anode 3 may be broken or the structure of the fuel cells damaged. Typically, a heavily oxidising atmosphere is created on the anode 3, when the temperature of the fuel cell unit 2 is 200-600° C., especially 400-550° C. Also the nickel material possibly present in the methanator/reformer 10 is oxidised in said conditions.

In order to prevent the oxidation of nickel the composition of the alcohol fuel is changed by mixing water therewith in the fuel channel 7. Water is mixed with the fuel in such situations, where the recirculation of exhaust gas from the anode 3 to the fuel channel 7 works with reduced effect. Then, after the necessary fuel processing stages (reforming, methanasing) a hydrogenous reducing gas mixture is formed already at a temperature of 200° C., in other words the gas possesses enough reducing power to maintain the nickel material of the anode 3 in a reduced state. The fuel composition is changed in this manner at temperatures, where an oxidising atmosphere may develop on the anode 3.

The fuel cell apparatus 1 comprises water feed means 22 for feeding water into the fuel channel 7 from a water tank 12 or another water source. The water feed means 22 comprise a water pump 18 and a water duct 13 adapted between the fuel channel 7 and the water source. Water is fed by the water pump 18 from the water tank 12 into the water duct 13 and via the water duct 13 into the fuel channel 7. The water duct 13 is connected to the fuel channel 7, in the flow direction of the fuel to a location before the reformer/methanator 10, preferably to a location between the fuel tank 6 and the evaporator 8. Water is introduced from the water duct 13 into the fuel channel 7 and mixed with the fuel flowing in the fuel channel 7. At the mixing point the fuel is unevaporated. The mixture of fuel and water is evaporated in the evaporator 8 and superheated in the superheater 9. The mixture of evaporated fuel and water vapour is cracked in the steam reformer/methanator 10, whereby hydrogenous fuel gas is provided. The fuel gas comprises methane (CH₄), hydrogen (H₂), carbon monoxide (CO), carbon dioxide (CO₂) and water vapour (H₂O). When the temperature of the fuel cell unit 2 is low, methane (CH₄) is produced only to a minor extent. The volume flow rate of the water to be introduced into the fuel channel 7 is controlled by means of the water pump 18. The volume flow rates of water and fuel can be controlled by the water pump 18 and the fuel pump 17, respectively, so that the fuel content of the fuel/water mixture flowing in the fuel channel 7 may vary between 0 and 100%. A measuring device 19 is adapted in conjunction with the anode 3 of the fuel cell unit to measure the temperature of the fuel cell unit. In addition, a second measuring device 21 is arranged in the fuel channel 7 to measure the hydrogen content of the fuel gas to be introduced to the anode 3. The measuring results of the measuring device 19 and the second measuring device 21 are transmitted to a control unit 20, which guides the water pump 18 and the fuel pump 17 on the basis of the respective measuring results.

In the start-up of the fuel cell apparatus 1 the water feed from the water feed means 22 into the fuel channel 7 is started, when the temperature of the fuel cell unit 2 has reached about 200° C., however, at the latest when the temperature is about 400° C. The amount of water to be mixed with the fuel flowing in the fuel channel 7 is such that the hydrogen content of the fuel gas after the reformer/methanator 10, i.e. the hydrogen content of the fuel gas to be introduced to the anode 3, is 5 volume percent at the most, preferably 4 volume percent at the most.

While the temperature of the fuel cell unit 2 rises, the exhaust gas flow to be recirculated from the anode 3 back to the fuel channel 7 is increased. This adds to the reducing power of the fuel gas to be led to the anode 3. While the temperature of the fuel cell unit 2 rises, the fuel feeding into the fuel channel 7 is increased and the water feed into the fuel channel 7 is decreased gradually in proportion to the increasing exhaust gas recirculation. When the temperature of the fuel cell unit 2 has reached the self-ignition temperature of hydrogen (about 585° C.), the water feed into the fuel channel 7 may be stopped entirely. Then, also the exhaust gas recirculation from the anode 3 to the fuel channel 7 is working to full extent. The water feed from water duct 13 into the fuel channel 7 is stopped, when the temperature of the fuel cell unit 2 is 550-600° C.

When shutting down the fuel cell apparatus 1, the above measures are taken in reverse order. The water feed from the water duct 13 into the fuel channel 7 is started, when the temperature of the fuel cell unit 2 drops to 600-550° C. The water feed is controlled so that the hydrogen content of the fuel gas to be conveyed to the anode is 5 volume percent at the most, preferably 4 volume percent at the most. When the temperature of the fuel cell unit 2 drops to 400-200° C., the water pump 18 is stopped and thus the water feed into the fuel channel 7 ceases completely. At the same time also the fuel feeding into the fuel channel 7 is stopped by turning off the fuel pump 17.

Water feed into the fuel channel 7 may be utilised also during the normal operation of the fuel cell apparatus 1 in a situation, in which the steam/carbon ratio of the mixture of alcohol fuel and recirculated gas of the anode is on too low a level. Then, water is introduced into fuel channel 7 by the water feed means 22 so that the steam/carbon ratio of the mixture can be set on desired level.

1-10. (canceled)

11. A method of operating a fuel cell apparatus, which fuel cell apparatus comprises a fuel cell unit, the fuel cells of which enclose an anode and a cathode and an electrolyte therebetween, a fuel channel for conveying fuel to the anode, and a processing apparatus arranged in conjunction with the fuel channel for producing a hydrogenous fuel gas from an alcohol fuel, in which method alcohol fuel is led to the processing apparatus along the fuel channel, hydrogenous fuel gas is produced from the alcohol fuel in the processing apparatus, fuel gas is led from the processing apparatus to the anode, fuel gas is combusted on the anode, and exhaust gas generated during the combustion of the fuel gas is discharged from the anode into the fuel channel to a location before the processing apparatus in the flow direction of the fuel and mixed with the fuel, wherein water is fed from a water source into the fuel channel and mixed with the alcohol fuel in the fuel channel before it is conveyed to the processing apparatus.

12. The method according to claim 11, wherein water is added to the alcohol fuel in the start-up phase and/or shut-down phase of the fuel cell apparatus.

13. The method according to claim 11, wherein the amount of water mixed with the alcohol fuel is such that the hydrogen content of the hydrogenous fuel gas after the processing apparatus is 5 volume percent at the most.

14. The method according to claim 11, wherein water is mixed with the alcohol fuel, when the temperature of the fuel cell unit (2) is 200-600° C., preferably 400-550° C.

15. The method according to claim 11, wherein the alcohol fuel is evaporated in an evaporator before it is led to the processing apparatus, and that water is added to the alcohol fuel in the fuel channel before it is led to the evaporator.

16. The method according to claim 11, wherein the temperature of the fuel cell unit is measured and the amount of water to be mixed with the alcohol fuel is adjusted on the basis of the temperature measurement.

17. A fuel cell apparatus comprising a fuel cell unit, the fuel cells of which enclose an anode and a cathode and an electrolyte therebetween, a fuel channel for conveying fuel to the anode, and a processing apparatus arranged in conjunction with the fuel channel for producing a hydrogenous fuel gas from an alcohol fuel, and a return channel for conveying exhaust gas from the anode to the fuel channel to a location before the processing apparatus in the flow direction of the fuel, wherein the fuel cell apparatus further comprises water feed means for feeding water from a water source into the fuel channel to a location before the processing apparatus.

18. The fuel cell apparatus according to claim 17, comprising a measuring device for measuring the temperature of the fuel cell unit and a control unit, which is arranged to control the amount of water fed into the fuel channel on the basis of the measurement result of the measuring device.

19. The fuel cell apparatus according to claim 17, wherein the anode comprises nickel or other easily oxidable metal.

20. The fuel cell apparatus according to claim 17, wherein an evaporator is adapted in conjunction with the fuel channel, and that the feed point of the water feed means is located in the fuel channel before the evaporator.
